(19) United States
(12) Patent Application Publication
(10) Pub. No.: US 2002/0191121 A1
(43) Pub. Date: Dec. 19, 2002

(54) Spring bracket for mounting cathode ray tubes in projection television devices

(75) Inventors: Stephen Womble Fleetwood, Knoxville, TN (US); Rodney Ballard, (US)

Correspondence Address: Corporate Patent Counsel, U.S. Philips Corporation, 580 White Plains Road, Tarrytown, NY, 10591, US

(73) Assignee: Koninklijke Philips Electronics, N.V.

(21) Appl. No.: 09/882,983

(22) Filed: Jun. 16, 2001

(51) Int. Cl. H04N 5/645

(52) U.S. Cl. 348/818; 348/825

(57) ABSTRACT

A simplified mounting bracket arrangement for a cathode ray tube (CRT) in a projection television system features a pair of brackets, each one comprised of a pair of elongated sheet metal springs that retain the CRT to a coupler chassis in a compressive arrangement using two screws or bolts.

### FIELD OF THE INVENTION

This invention relates to the field of projection television (PTV), and more particularly to a mounting bracket for securing cathode ray tubes in a PTV chassis.

### BACKGROUND OF THE INVENTION

In conventional projection television (PTV) applications, cathode ray tubes (CRTs) are typically secured to a mounting chassis using a stamped metal bracket, which is shaped to provide a collar around the neck of the CRT and is held in place with four compression springs. Additionally included in such a mounting configuration are four shoulder bolts for securing one end of each spring to the bracket, the other spring-end being secured to a chassis mounting point.

Disadvantageously, both the cost and number of assembly steps and components required to secure a CRT to a mounting chassis are less than optimal. Further, the size of this mounting arrangement brings the ground potential metal bracket physically close to a high voltage anode boot, exposing the PTV to arcing if the insulating boot is misaligned or degraded with age.

### SUMMARY

A simplified mounting bracket arrangement for a cathode ray tube (CRT) in a projection television system (PTV) features a pair of brackets, each one comprised of a pair elongated sheet metal springs that retain the CRT to a coupler chassis of the PTV in a compressive arrangement using two screws or bolts. The sheet metal springs are shaped such that when the two springs are connected together, a first spring attaches to a chassis coupler, while a second spring presses against a rear surface of the CRT, holding it in a secure arrangement against the coupler. The two brackets are arranged on opposite sides of the CRT funnel to hold the CRT in a semi-rigid arrangement.

### BRIEF DESCRIPTION OF THE DRAWINGS

FIG. 1 shows a cathode ray tube of a projection television system being secured using a mounting arrangement according to the present invention.

FIG. 2 shows a perspective view of a PTV CRT being attached using a pair of complementary brackets as shown in FIG. 1.

### DETAILED DESCRIPTION OF THE INVENTION

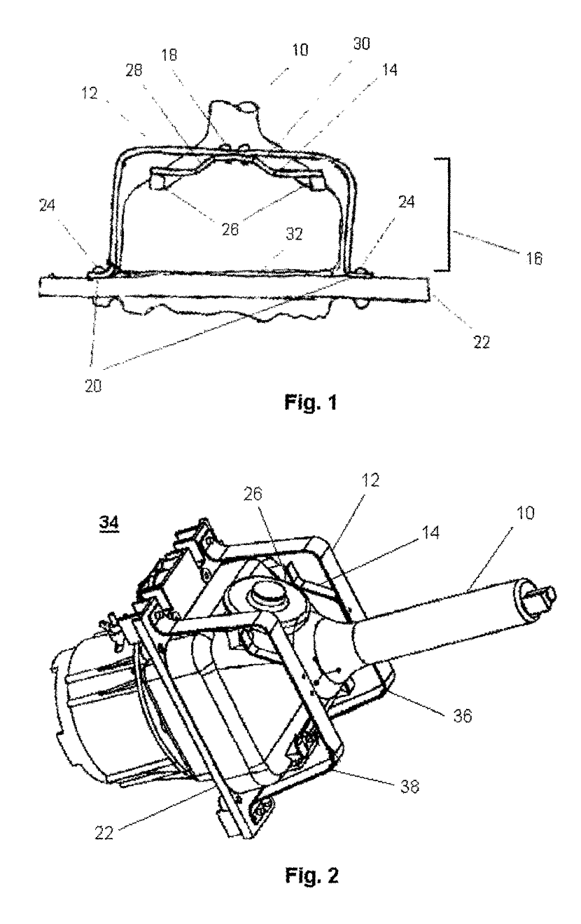

FIG. 1 shows a cathode ray tube (CRT) 10 of a projection television system (PTV) being secured using a mounting arrangement according to the present invention. A first spring 12 and a second spring 14 are attached together to form a bracket 16. A second bracket 16 is mounted on an opposite side of the CRT funnel. Some exemplary materials used in constructing springs 12 and 14 can be sheet metal, steel, plastic, etc and exemplary attaching means can preferably be one or two screws 18, bolts with nuts, or rivets to hold the two springs in a generally rigid alignment with each other at their midpoints.

First spring 12, which is preferably U-shaped, has a mounting flange 20 at each end of the spring, allowing flange 20 to be semi-permanently connected to a rigid chassis or coupler 22 via screws or bolts with nuts 24 through a mounting hole located in each flange 20. Second spring 14 has a complex trapezoidal shape generally having five tensioned segments and is formed as shown in FIG. 1 such that the first and last segments will generally present a parallel surface to one or more small resilient interfacing pads 26 with CRT 10 along a common axis. It can be appreciated that the shape can include sharp or “soft” corners at the segment junctions and still provide a necessary tension to hold CRT 10 in place.

The “flat” surface mating arrangement is preferable to a pointed one, wherein a protruding end of a segment can puncture pad 26 and possibly damage CRT 10. The tension provided by the angular segments 28 and 30 should be sufficient to hold the CRT 10 in place during jarring occurrences such as drops or bumps. Additionally, a padded seal 32 provides a cushion between fragile CRT 10 and rigid coupler 22 to ameliorate the pressure being applied by bracket 16 to the funnel of CRT 10. Seal 32 is squeezed sufficiently to prevent any lateral displacement of CRT 10 during an oblique drop, etc.

FIG. 2 shows a perspective view of an exemplary PTV CRT 34 being attached using a pair of complementary brackets 36 and 38 as shown in FIG. 1. Given the circular nature of the CRT, brackets will preferably be symmetrical about the funnel of the CRT and connected to coupler 22. Elements of bracket 36 are labeled for clarity, and include first spring 12, second spring 14, resilient interfacing pads 26, and CRT 10 as detailed in FIG. 1 above.

A significant advantage of the preferred embodiment of the present invention is that the resulting elongated bracket is smaller and has fewer parts than a conventional CRT mounting arrangement, with attendant reduced manufacturing material content and assembly time. Further, system reliability and safety is improved, since the smaller-sized bracket provides more clearance between the grounded metal bracket 16 and a high voltage CRT anode connector.

It can be appreciated that other materials and tension-generating shapes can be used to manufacture bracket 16 other than the exemplary ones cited above. Further, the mounting arrangements and details can be varied to include other materials and other mechanical fastening devices and/or components and still fall within the scope of the invention.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention Details of the embodiment may be varied without departing from the spirit of the invention, and the exclusive use of all modifications which come within the scope of the appended claims is reserved.

What is claimed is:

1. An article of manufacture for compressively securing a cathode ray tube (CRT) to a coupler in a projection television system, comprising
a first spring;
a second spring;
a mechanical coupling means for coupling the first and second springs together;
a first securing means for attaching the first spring to a coupler; and
a second securing means for securing the CRT to the assembled spring arrangement.

2. The article according to claim 1, wherein the first and second springs are constructed of sheet metal.

3. The article according to claim 1, wherein the first and second springs have a generally elongated shape in a first plane.

4. The article according to claim 3, wherein the first spring has a generally U-shape in a second plane, and is terminated at each end with a mounting flange.

5. The article according to claim 3, wherein the second spring has a shape that is generally trapezoidal, having at least five segments that are contiguously joined, in that:
a first lateral segment is ended at a boundary with a second segment;
said second segment is oriented an angular displacement from the first segment and traversing both laterally and vertically and ending at a boundary with a third segment;
said third segment traversing laterally and parallel to the first segment is ended at a boundary with a fourth segment;
said fourth segment traverses at an angular displacement, such that an adjoining fifth segment has an orientation and axis that is identical to that of the first segment.

6. The article according to claim 1, wherein the mechanical coupling means comprises:
at least one annulus completely through each spring at a general midpoint of each of the first and second springs for accepting;
at least one securing device for attaching the first and second springs together in a generally semi-permanent manner.

7. The article according to claim 6, wherein the securing device comprises one or more from the group consisting of a screw and a bolt with a retaining nut.

8. The article according to claim 1, wherein the first securing means comprises at least one from the group consisting of a screw and a bolt with a retaining nut.

9. The article according to claim 1, wherein the second securing means comprises at least one resilient spacer pad located between the second spring and surface of the CRT.

10. The article according to claim 1, additionally comprising a resilient seal juxtaposed between the CRT and the coupler, such that lateral movement of one to the other is inhibited.

11. A mounting apparatus for securing a cathode ray tube (CRT) to a chassis coupler in a projection television system comprising at least a first and a second tensioned bracket in compressive arrangement with a rear surface of said CRT, each tensioned brackets further comprising;
a first spring element;
a second spring element;
a first attaching means for coupling the first and second spring elements together;
a second attaching means for coupling the first spring element to the coupler; and
a third attaching means for compressively coupling the second spring element to the CRT.

12. The mounting apparatus according to claim 11, wherein the first and the second tensioned bracket are symmetrical.

13. The mounting apparatus according to claim 11, wherein the first and the second tensioned bracket are not symmetrical.
